(19) United States
(12) Patent Application Publication
(10) Pub. No.: US 2026/0153102 A1
(43) Pub. Date: Jun. 4, 2026

(54) Device

(71) Applicant: Hydac Technology GmbH, Sulzbach / Saar (DE)

(72) Inventors: Norbert Weber, Saarbrücken (DE); Yannik ZIMMER, St. Wendel-Hoof (DE); Sven Daniel Günter MANN, Püttlingen (DE)

(73) Assignee: Hydac Technology GmbH, Sulzbach / Saar (DE)

(21) Appl. No.: 19/122,947

(22) PCT Filed: Apr. 16, 2024
(86) PCT No.: PCT/EP2024/060281

§ 371 Date: Apr. 21, 2025

(30) Foreign Application Priority Data
May 17, 2023 (DE) 10 2023 002 019.2

(51) Int. Cl. F15B 15/16; F15B 1/04; F16L 55/053

(52) U.S. Cl. CPC F15B 15/16; F15B 1/04; F16L 55/053

(57) ABSTRACT

The disclosure relates to a device, in particular for volume compensation in fluid circuits, at least consisting of a device housing and a compensating element which is movably guided therein, that can be acted on by a fluid pressure and is supported on an energy storage device, wherein the device housing has at least two housing parts, which are arranged one behind the other when viewed along the longitudinal axis of the device housing, wherein the adjacent housing parts differ in their free cross-sectional areas, and wherein the transition from one housing part to the subsequent, adjacent housing part is in the form of a step.

### CROSS-REFERENCE TO RELATED APPLICATIONS

This application claims priority to German Patent Application DE 10 2023 002 019.2, filed on May 17, 2023 with the German Patent and Trademark Office. The contents of the aforesaid Patent Application are incorporated herein for all purposes.

### BACKGROUND

This background section is provided for the purpose of generally describing the context of the disclosure. Work of the t presently named inventor(s), to the extent the work is described in this background section, as well as aspects of the description that may not otherwise qualify as prior art at the time of filing, are neither expressly nor impliedly admitted as prior art against the present disclosure.

The disclosure relates to a device in particular for volume compensation in fluid circuits, at least consisting of a device housing and a compensating element which is movably guided therein, that can be acted on by a fluid pressure and is supported on an energy storage device.

EP 3 191 717 B1 discloses a device for relieving pressure in hydraulic lines, in particular in connecting lines that have coupling points between attachments comprising hydraulically actuatable actuators and work equipment supplying said attachments, having a control block which is connected to the line to be relieved and which includes an unlockable non-return valve as a relief valve, having a pressure accumulator which receives a relief volume when the non-return valve is unlocked, and having an actuating element which can be moved manually in order to unlock the non-return valve and which is movably arranged on the device housing of the pressure accumulator, the pressure accumulator being designed as a spring accumulator that has an axially movable accumulator piston as a compensating element, which is loaded by a compression spring as an energy storage device on its side facing away from the fluid chamber and through which a coaxial actuating rod passes, the inner end of said actuating rod extending through a fluid inlet of the device housing to the closing body of the non-return valve. Furthermore, an actuating button for manual displacement of the actuating rod is attached on the outer end of the actuating rod, which protrudes above the outside end of the device housing of the accumulator. In the known solution, the device housing is formed by a cup-like, one-piece housing part with a hollow-cylindrical jacket and with an inner cross-sectional area with a constant diameter.

Corresponding spring accumulators offer a maintenance-free alternative to gas-filled pressure accumulators as refilling on the gas side is not necessary. A non-temperature-dependent characteristic curve may be regarded as a further benefit, thus making it possible to cover a broad temperature range without any impact on the pressure-volume curve, as in the case of hydropneumatic accumulators.

### SUMMARY

A need exists to provide an improved device, in particular one that increases the possible range of applications.

The need is addressed by the subject matter of the independent claim(s). Embodiments of the invention are described in the dependent claims, the following description, and the drawings.

### BRIEF DESCRIPTION OF THE DRAWINGS

FIGS. 1 and 2 show two different embodiments of a device in the form of a simplified longitudinal sectional view and in an initial state.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the device housing has at least two housing parts which are arranged one behind the other when viewed along the longitudinal axis of the device housing, and the adjacent housing parts differ in their free cross-sectional areas, and the transition from one housing part to the subsequent, adjacent housing part is in the form of a step. In some embodiments, the device housing can be usefully adapted to a broad range of installation conditions on site. In particular, the device can be accommodated in a space-saving manner in restricted installation spaces due to the aforementioned adaptation to the housing parts of the device housing. Despite the change in the cross-sectional area and the associated different housing part shape, a rigid housing configuration is achieved overall, which also readily withstands high actuating forces.

The device according to the teachings herein may for example be used to compensate volumes in closed fluid circuits in order to thus compensate for a change in volume over temperature. In this manner, the device can be used in both high-pressure and low-pressure ranges.

The aforementioned step for example consists of an annular surface arranged concentrically in relation to the longitudinal axis of the device housing, said surface creating a continuous transition between two adjacent housing parts. For example, in this case, the step consists of a truncated cone, the notional base surface of which transitions into the housing part with the larger free cross-sectional area and the notional top surface of which transitions into the adjacent housing part with the smaller cross-sectional area. In this manner, a harmonious transition is created between the different housing parts of the device housing such that any stress peaks that arise in this material region can be readily compensated and any loads introduced by the step are distributed uniformly in the direction of both adjoining housing parts.

In some embodiments of the device, it is provided that the respective adjacent housing parts are formed by hollow cylinders with circular cross-sectional areas and that each hollow cylinder has a cross-sectional area with a diameter that differs from the diameter of the other cross-sectional area.

For example, in this case, it is further provided that the housing part with the respective larger free cross-sectional area guides the compensating element and the adjacent housing part with the correspondingly smaller cross-sectional area receives at least part of the energy storage device. In this manner, hydraulic loading of the device is able to take place via a side that opens outwards in the device housing, without being adversely affected in this process by the installation of the energy storage device in the device housing.

In some embodiments of the device, it is provided that the energy storage device is formed by at least one, for example two, compression springs, the spring wire of which extends in a spring chamber from the compensating element to an end in the device housing. Particularly when using two compression coil springs, it is possible to reduce the length of the installation space in relation to the device housing compared with a solution with only one spring and the same spring force of two springs.

In this case it is for example provided that an external spring wire surrounds the internal spring wire in a concentric arrangement in relation to the longitudinal axis of the device housing and for example has a greater spring stiffness than the internal spring wire. For example, in this case, at least part of the external spring wire can be guided inside the housing part with the smaller free cross-sectional area and, in this manner, supported outwards to prevent kinking, which benefits the overall guidance of the overall spring arrangement in the device housing. In this manner, the external spring also provides additional support for the internal spring.

To ensure a particularly rigid structure of the spring arrangement it is provided that the coil pitches of the two compression springs, which are arranged concentrically with respect to one another, are different from one another and for example configured to be cylindrical.

In some embodiments of the device, it is provided that a guide means is arranged inside the device housing, said guide means protruding into the spring chamber at least for part of the compression springs and offering support during operation thereof. In the case of low pressures and relatively large volume displacements, correspondingly long springs need to be used, which generally have a tendency to kink. Thanks to the guide means, which at least partially guides the internal spring wire, corresponding kinking is effectively countered.

In this case, the guide means is for example formed by a cylindrical body, the inside of which is in media connection with the spring chamber such that hindrances during operation due to any trapped air volumes are avoided. For example, the cylindrical body is formed by a telescopic tube, which, by means of a resetting apparatus, in particular in the form of a magnet, can be reset from a retracted position by means of the compensating element, which is for example configured to be piston-like, into its extended initial position. Thanks to the telescopic guide means, effective support for the respective compression spring on its respective inner side can be achieved over a very broad displacement path of the piston-like compensating element. In this process, the piston-like compensating element is able to displace a telescopic outer tube in relation to a telescopic inner tube on reaching a corresponding loading stroke inside the device housing. The aforementioned telescopic embodiment also permits stabilisation of the accumulator characteristic curve and leads to reduced friction for the piston-shaped compensating element. The compensating element's tendency to tilt is also reduced, this being otherwise regularly caused by kinking of narrow wires. However, the very risk of corresponding kinking is effectively countered by the device solution according to the teachings herein.

In some embodiments of the device, it is provided that the cylindrical body, in particular in the form of the telescopic tube, emerges into a pressure compensating element on the side of the end that is configured in the form of a lid, said pressure compensating element engaging through the lid-like end. The device housing with its individual housing parts emerges on its free end face into a housing base which forms the end of the device housing.

The pressure compensating element is used in the corresponding lid-like end, ambient air being able to be admitted to or discharged from the inside of the device housing via said pressure compensating element according to the displacement direction of the compensating element. By virtue of the pressure compensating element, enclosed air can thus not be compressed inside the device housing or spring chamber with the result that unobstructed operation of the device is possible at all times. In this manner, a kind of breathing system is achieved, particularly in the form of a spring accumulator.

The hollow-cylindrical housing parts connected to one another via the step for example have the same wall thickness. In this process, the device housing is for example constructed in one piece with its individual housing parts and can for example be obtained in one process step by means of a cold forming method. As such, the individual cylindrical jacket surfaces of the housing parts that are connected to one another via the step therefore form a one-piece cold-formed part, for example together with the lid-like end.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are schematic and not necessarily to scale.

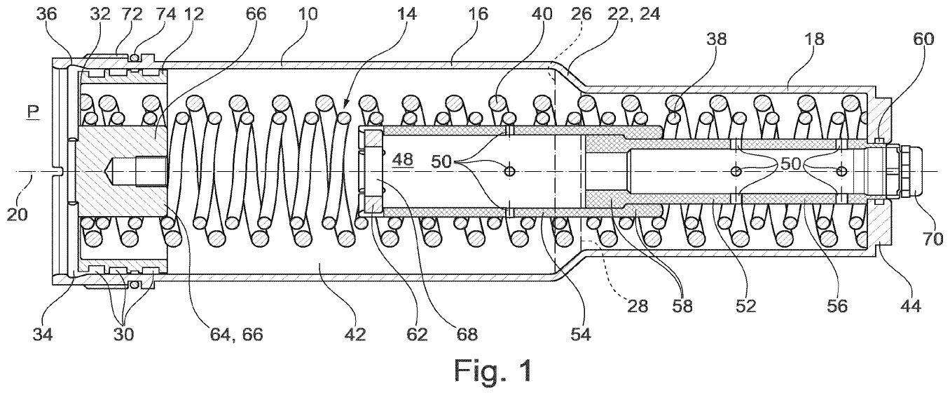

The device shown in FIG. 1 comprises a device housing 10 with a compensating element 12 mounted in a longitudinally displaceable manner therein, which, as viewed in FIG. 1, can be acted on by a fluid pressure p on the left and supported on the right on an energy storage device 14.

The device housing 10 has two housing parts 16, 18 which are arranged one behind the other when viewed along the longitudinal axis 20 of the device housing 10. The adjacent housing parts 16, 18 differ in their free cross-sectional areas, the transition from one housing part 16 to the subsequent, adjacent housing part 18 being in the form of a step 22.

The step 22 consists of an annular surface 24 arranged concentrically in relation to the longitudinal axis 20 of the device housing 10, said annular surface creating a continuous transition between the two adjacent housing parts 16, 18. In particular, the step 22 consists of a truncated cone, the notional circular base surface 26 of which, reproduced as a dashed line, transitions into the housing part 16 with the larger free cross-sectional area. The notional top surface 28, which is also reproduced as a dashed line, of the truncated cone emerges into the adjacent housing part 18 with the smaller free cross-sectional area compared thereto. The top surface 28 also has a circular cross-section like the base surface 26.

The respective adjacent housing parts 16, 18 consist of hollow cylinders with circular cross-sectional areas, each hollow cylinder having a cross-sectional area with a diameter that differs from the diameter of the other cross-sectional area. As is also shown in FIG. 1, the housing part 16 with the respective larger free cross-sectional area guides the compensating element 12, whereas the adjacent housing part 18, adjoining via the step 22, with the correspondingly smaller cross-sectional area receives at least part of the energy storage device 14.

The compensating element 12 consists of a cylindrical hollow piston, which, on its outer circumferential side, has the usual guide and sealing devices, only the associated annular grooves 30 thus being shown in FIG. 1 for ease of representation. The piston-like compensating element 12 slides with its outer circumference via the corresponding guide and sealing devices, which are not shown, along the cylindrical inner circumferential area of the first housing part 16. As such, the conically tapering step 22 forms a possible stop for the compensating element 12 in the direction of the free end of the device housing 10, which is opposite the compensating element 12. Furthermore, the compensating element 12 as depicted in FIG. 1 is in its unactuated initial position and is thus supported on its side facing the fluid pressure p along the outer circumference of its piston base 32 on a snap ring 34, which is received across the orientation of the longitudinal axis 20 in an associated inner circumferential groove 36 of the first housing part 16.

The aforementioned energy storage device 14 consists of two compression springs 38, 40, the spring wire of which extends in a spring chamber 42 from the compensating element 12 to a lid-like end 44 in the device housing 10. The external spring wire of the second compression spring 40 surrounds the internal spring wire of the first compression spring 38 in a concentric arrangement in relation to the longitudinal axis 20 and, for example, the second compression spring 40 has a greater spring stiffness than the first compression spring 38 with its internal spring wire. The coil pitches of the two compression springs 38, 40, which are arranged concentrically in relation to one another, are different from one another and, in particular, as viewed in FIG. 1, the coil pitch of the first compression spring 38 is oriented towards the right and that of the second compression spring 40 towards the left. Furthermore, the compression springs 38, 40, which are accordingly configured as helical compression springs, are configured to be substantially cylindrical. The two compression springs 38, 40 are supported with their free ends on the inside of the piston base 32 in one case and on the inside of the lid-shaped end 44 in the other case.

As is also shown in FIG. 1, a guide means 46 is arranged, running concentrically in relation to the longitudinal axis 20, inside the device housing 10, said guide means protruding into the spring chamber 42 at least for part of the compression springs, in particular for the innermost compression spring 38 during operation, offering support during operation thereof. As such, the guide means 46 at least partially guides the internal spring wire of the compression spring 38. The guide means 46 is formed by a cylindrical body, the inside 48 of which is in media connection with the spring chamber 42. For this purpose, the cylindrical body has individual passages 50 in the cylindrical body wall, which are divided into three groups and extend diametrically around the longitudinal axis 20. Depending on the size of the respective passage 50, these can also be configured in the form of apertures and also support intentional damping.

In the embodiment shown in FIG. 1, the cylindrical body is formed by a telescopic tube 52 with a telescopic outer tube 54 and a telescopic inner tube 56. While the telescopic inner tube 56 is fixed in a stationary manner at its one free end region on the lid-like end 44, the telescopic outer tube 54 is guided in a longitudinally displaceable manner along the outer circumference of the telescopic inner tube 56. As such, both tubes 54, 56 are in permanent engagement with one another via correspondingly configured stops 58. Furthermore, a sealing ring 60 is provided in the connection region 44 and on the telescopic inner tube 56, said sealing ring sealing the spring chamber 42 and the inside 48 of the telescopic tube 52 from the environment. The telescopic outer tube 54 has on its free end face, which faces away from the end 44, an annular magnet 62 as part of a resetting apparatus 64. A cylindrical steel body 66 is a further part of the corresponding resetting apparatus 64, said steel body for example being an integral part of the piston base 32 of the compensating element 12. The annular magnet 62 releases a central opening 68, via which the inside 48 of the telescopic tube 52 is able to exchange media with the spring chamber 42. Instead of a steel body 66, a comparable body may also be manufactured from aluminium or a plastic construction, which then comprises on its end face a corresponding magnet or steel part, for example in the form of a small plate.

If a fluid pressure p exerts a larger force on the outer piston surface of the compensating element 12 than the spring force of the two compression springs 38, 40, the piston-like compensating element 12 is displaced, as viewed in FIG. 1, from its initial position shown on the left in a right-hand displacement movement, the spring force increasing in this manner by compression of the two compression springs 38, 40. At maximum fluid pressure p the free end face of the steel body 66 comes into contact with the free end face of the telescopic outer tube 54 and carries this with it accordingly to the right. In this process, the telescopic outer tube 54 slides onto the telescopic inner tube 56 up to a maximum possible stop position, in which the telescopic outer tube 54 comes into contact with the lid-like end 44.

However, as a rule, the spring counterforce may already be sufficient at an earlier point in time to effectively counter the fluid pressure p with the result that the telescopic outer tube 54 does not necessarily reach its stop position and/or the compensating element 12 does not necessarily come into contact with the step 22. If the fluid pressure p decreases completely, the two compression springs 38, 40 are relieved and the piston-like compensating element 12 in turn passes into its left-hand stop position with the snap ring 34 arranged in a stationary manner in the first housing part 16. Intermediate positions for the compensating element 12 are possible depending on the force equilibrium between the fluid pressure p and the spring force. However, in the resetting movement, the steel body 66 carries the annular magnet 62 along with it such that the telescopic tube 52 with its two tubes 54, 56 is in turn able to assume its initial position shown in FIG. 1. For the corresponding resetting movement, it is not absolutely essential for the steel body 66 to come into contact with the annular magnet 62; instead, the magnetic force must merely be sufficient to carry out the corresponding resetting movement, with the ability to overcome the friction force of the outer tube 54 on the outer circumferential side of the internal tube 56 in any event.

As is also shown in FIG. 1, in any event the inner circumference of the second housing part 18 with the reduced diameter provides an outward support for the outer compression spring 40 such that kinking outwards in this region is thus not possible. Furthermore, inward kinking of the first compression spring 38 is thus in any event impossible as the spring wire of the inner compression spring 38 can be supported on the outer circumference of the telescopic outer tube 54 in each of its displacement positions. Further support for the two compression springs 38, 40 is provided by their concentric arrangement, in which spring wire parts of the two compression springs 38, 40 in some cases come into contact with one another when under load.

Furthermore, the device comprises a pressure compensating element 70, which engages through the lid-like end 44 and emerges into the environment on one side and on the other side into the inside 48 of the stationary telescopic tube 52. Thanks to the pressure compensating element 70, a kind of breathing system is achieved, in particular in the form of a spring accumulator, and, according to the displacement direction of the compensating element 12, ambient air can be admitted to or discharged from the inside of the device housing 10 in this manner. For example, the pressure compensating element 70 comprises a diaphragm, which is not shown, to prevent the ingress of contamination, such as water or dirt. In this manner, there is an exchange between the ambient air and the inside of the device housing 10, in particular in the form of the spring chamber 42, without the air enclosed therein being compressed, with the result that variable pressure adjustment is substantially determined by the prevailing fluid pressure p and the spring tension of the two compression springs 38, 40. It is clear that the device solution can also be used with just one compression spring if necessary given a spring with a correspondingly rigid construction.

The hollow-cylindrical housing parts 16, 18 connected to one another via the step 22 have the same thin wall thickness such that the device housing 10 is configured in one piece with its housing parts 16, 18 and is for example obtained by means of a cold forming method. Depending on the forming method used, the respective wall thickness may also be configured to be thicker or to have different thicknesses. A thin-walled configuration is for example purely for weight reasons. As such, the device housing 10 with its base end part 44 may consist of a suitable steel material or for example aluminium. As the compensating element 12 is secured outwards via the snap ring 34, a cover on the oil side of the device housing 10 is not required. If the aforementioned spring accumulator, the device housing 10 of which conveys air and is in particular used for volume compensation in closed circuits at lower pressures, a great many components, especially in the form of the guide means 46, can be manufactured from plastics.

Furthermore, an outer thread 72 can be applied to the base side of the device housing 10 adjacent to the snap ring 34 on the outer circumferential side such that the device in its entirety can be screwed into a housing block, which is not shown, in a kind of cartridge structure, said housing block having at least one fluid guide means, which supplies the fluid pressure p. The corresponding fluid pressure p is generally generated by a fluid, for example in the form of a hydraulic medium, in a fluid circuit. Overall, a continuous radial spring guide means for the respective compression spring 38, 40 is achieved with the device solution according to FIG. 1. The configuration of the device housing 10 as a cold-formed part permits reliable absorption of the actuating forces arising during operation, determined by the fluid pressure p and the spring force of the respective compression springs 38, 40. In the region of the outer thread 72, there is a further sealing ring 74, which, when the device housing 10 is screwed into a housing block or similar, provides a reliable seal between the inside of the block and the environment.

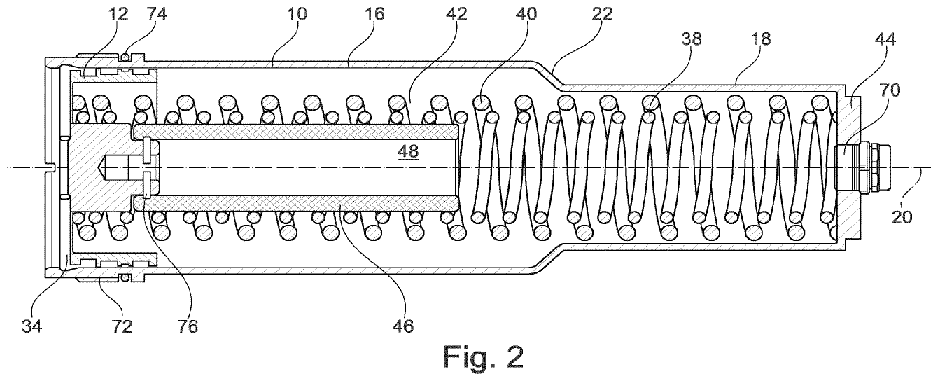

A further embodiment according to FIG. 2 is described below and this is only explained insofar as it differs substantially from the embodiment shown in FIG. 1. If individual structural components from FIG. 1 are used in the embodiment shown in FIG. 2, the same reference numerals used in FIG. 1 are used for said components and the explanations provided for these components also apply to the solution according to FIG. 2. In the embodiment depicted in FIG. 2, instead of a telescopic tube 52, a guide means 46 with an individual cylindrical body is used, on the outside of which the spring wire of the inner compression spring 38 can in turn be supported. The corresponding tubular guide means 46 is clipped, in the region of a carrier, for example in the form of a cylindrical steel body 66, to said carrier via a further snap ring 76 and is moreover open at its opposite free end such that the inside 48 of the guide means 46 in turn emerges into the spring chamber 42. Furthermore, in the corresponding embodiment the pressure compensating element 70 emerges on the inside of the device housing 10 or in the spring chamber 42 respectively. The hollow-cylindrical guide means 46 is synchronously picked up by means of the compensating element 12 in a movement from left to right until the free end face of the guide means 46 comes into contact with the wall-like end 44, which thus forms a stable stop. In the direction of this stop, the inner circumference of the guide means 46 thus surrounds parts of the outer circumference of the pressure compensating element 70, which permits improved guidance in the stop region. To relieve the pressure on the step 22 in the embodiment depicted in FIG. 1, it can however be provided that the telescope reaches the stop before the piston-shaped end part 12 comes into contact with the step 22. In this manner, pressure on the accumulator housing 10 is relieved during operation in both embodiments.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1-16. (canceled)

17. A device, at least comprising a device housing and a compensating element which is movably guided therein, which compensating element can be acted on by a fluid pressure and is supported on an energy storage device, wherein the device housing has at least two housing parts, which are arranged one behind the other when viewed along the longitudinal axis of the device housing, wherein the adjacent housing parts differ in their free cross-sectional areas, and wherein the transition from one housing part to the subsequent, adjacent housing part is in the form of a step.

18. A The device of claim 17, wherein the step comprises an annular surface arranged concentrically in relation to the longitudinal axis of the device housing, said annular surface creating a continuous transition between two adjacent housing parts.

19. A The device of claim 17, wherein the step comprises a truncated cone, the notional base surface of which transitions into the housing part with the larger free cross-sectional area and the notional top surface of which transitions into the adjacent housing part with the smaller cross-sectional area.

20. A The device of claim 17, wherein the respective adjacent housing parts are formed by hollow cylinders with circular cross-sectional areas and wherein each hollow cylinder has a cross-sectional area with a diameter that differs from the diameter of the other cross-sectional area.

21. A The device of claim 17, wherein the housing part with the respective larger free cross-sectional area guides the compensating element and the adjacent housing part with the correspondingly smaller cross-sectional area receives at least part of the energy storage device.

22. A The device of claim 17, wherein the energy storage device is formed by at least one compression springs, the spring wire of which extends in a spring chamber from the compensating element to an end in the device housing.

23. A The device of claim 17, wherein an external spring wire surrounds the internal spring wire in a concentric arrangement in relation to the longitudinal axis of the device housing.

24. A The device of claim 17, wherein the coil pitches of the two compression springs that are arranged concentrically with respect to one another are different from one another.

25. A The device of claim 17, wherein a guide is arranged inside the device housing, said guide protruding into the spring chamber at least for part of the compression springs and offering a support in operation thereof.

26. A The device of claim 17, wherein the guide at least partially guides the internal spring wire.

27. A The device of claim 17, wherein the guide is formed by a cylindrical body, the inside of which is in media connection with the spring chamber.

28. A The device of claim 17, wherein the cylindrical body is formed by a telescopic tube, which, using a resetting apparatus, can be reset from a retracted position using the compensating element into its extended initial position.

29. A The device of claim 17, wherein the cylindrical body emerges into a pressure compensating element on the side of the end which is configured in the form of a lid, said pressure compensating element engaging through the lid-like end.

30. A The device of claim 17, wherein, in the form of a breathing system, ambient air can be admitted to or discharged from the inside of the device housing according to the displacement direction of the compensating element using the pressure compensating element.

31. A The device of claim 17, wherein hollow-cylindrical housing parts connected to one another via the step have the same wall thickness.

32. A The device of claim 17, wherein the device housing is configured in one piece with its housing parts.

33. A The device of claim 17, configured for volume compensation in fluid circuits.

34. A The device of claim 18, wherein the step comprises a truncated cone, the notional base surface of which transitions into the housing part with the larger free cross-sectional area and the notional top surface of which transitions into the adjacent housing part with the smaller cross-sectional area.

35. A The device of claim 18, wherein the respective adjacent housing parts are formed by hollow cylinders with circular cross-sectional areas and wherein each hollow cylinder has a cross-sectional area with a diameter that differs from the diameter of the other cross-sectional area.

36. A The device of claim 19, wherein the respective adjacent housing parts are formed by hollow cylinders with circular cross-sectional areas and wherein each hollow cylinder has a cross-sectional area with a diameter that differs from the diameter of the other cross-sectional area.
